(19) United States
(12) Patent Application Publication
(10) Pub. No.: US 2026/0171703 A1
(43) Pub. Date: Jun. 18, 2026

(54) CARD CONNECTORS

(71) Applicant: Hewlett-Packard Development Company, L.P., Spring, TX (US)

(72) Inventors: Hsin-Tso Lin, Taipei City (TW); Hung-Sung Pan, Taipei City (TW)

(73) Assignee: Hewlett-Packard Development Company, L.P., Spring, TX (US)

(21) Appl. No.: 19/118,208

(22) PCT Filed: Oct. 14, 2022
(86) PCT No.: PCT/US2022/046776

§ 371 Date: Apr. 3, 2025

(51) Int. Cl. H01R 13/20; H01R 12/57; H01R 12/71; H01R 12/72; H01R 13/629

(52) U.S. Cl. CPC H01R 13/20; H01R 12/57; H01R 12/714; H01R 12/721; H01R 13/629

(57) ABSTRACT

According to an example, a card connector comprises a damp member including a connector, and a holder member including a base portion defining an aperture and a protruding portion extending from the base portion. The clamp member and the protruding portion of the holder member are to receive an expansion module in a gap therebetween, and upon insertion of the expansion module into the gap, the connector of the clamp member is to engage with a complementary connector of the expansion module.

### BACKGROUND

Electronic devices such as computing devices may include hardware modules (e.g., storage units, RAM, WWAN cards, among others) to expand or increase their functionalities. In some examples, the hardware modules of the computing device may be removably connected to a region of the computing device (for instance, a housing, a printed circuit board, or a chassis of the device) via card connectors. To assure that removable modules are extracted and inserted appropriately, a wide variety of card connectors may be used.

### BRIEF DESCRIPTION OF DRAWINGS

Features of the present disclosure are illustrated by way of example and are not limited in the following figure(s), in which like numerals indicate like elements, in which:

FIG. 1 shows a detailed view of a card connector for receiving expansion modules, according to an example of the present disclosure;

FIG. 2 shows an exploded view of a card connector, according to an example of the present disclosure;

FIG. 3 shows a detailed view of a clamp member of a card connector, according to an example of the present disclosure;

FIG. 4 shows a detailed view of a card connector holding an expansion module, according to an example of the present disclosure;

FIG. 5A shows a first section view of the card connector and the expansion module of FIG. 4;

FIG. 5B shows a second section view of the card connector and the expansion module of FIG. 4;

FIG. 6 shows a detailed view of a computing system comprising a card connector, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to.

Electronic devices such as computing devices use some of their hardware components to perform computing operations (e.g., inputting operations, processing operations, outputting operations, storing operations, and controlling operations). In some examples, electronic devices may be configured to receive additional hardware components. In some examples, these additional hardware components may be removably connected to the electronic device. Accordingly, the performance of the electronic device during computing operations may depend on the hardware components connected to the electronic device. Likewise, the functionalities of the electronic device may be modified based on the type of hardware components connected to the electronic device.

To receive hardware components, electronic devices may comprise card connectors. In some examples, card connectors may include an interface connector to interface with a complementary region of a hardware module. Upon connecting the hardware module to the interface connector, the hardware module is operatively connected to the electronic device. To securely attach the hardware module to the electronic device, card connectors may include a plurality of fixing elements. In some examples, a hardware module may be attached to the electronic device via fixing members distributed along the surface of the hardware module.

Due to the limited space within an electronic device and the different form factors of the hardware modules, the number of card connectors in an electronic device may be limited. As a result, the number of hardware modules that may be connected to the electronic device at the same time is constrained. Also, in some examples, the use of hardware modules may be associated with high power consumption and high heat production. In some examples, to dissipate the additional heat generated by the additional hardware modules, the electronic device may have to use additional cooling resources. Accordingly, the additional cooling resources may further reduce the available space within the electronic device and on a surface of the electronic device.

Disclosed herein are examples of card connectors to receive hardware modules for electronic devices, system boards including card connectors, and computing systems including at least one card connector. Hence, different examples of card connectors, system boards, and computing systems are described.

As used herein, the term “computing device” will be used to refer to electronic devices having processor resources and memory resources. Examples of computing devices comprise desktop computers, laptop or notebook computers, networking devices such as routers or switches, and all-in-one computers.

Throughout the description, the term “expansion module” will be used to refer to hardware modules that modify the functionalities or characteristics of an electronic device attached thereto. Examples of expansion modules may include, among others, storage modules (e.g., solid state drives), RAM cards, and wireless wide area network (WWAN) cards.

As explained above, the use of expansion modules in an electronic device is constrained by the available space within the device and the available cooling resources in the electronic device. In some examples, expansion modules may be held in the electronic device using support structures that fix the expansion module to the electronic device in a horizontal position in which the largest surface of the expansion module in terms of area is attached to a surface of the electronic device or parallel thereto.

According to an example, a card connector for receiving an expansion module may be arranged to reduce overlap between the expansion module and a reference surface on which the card connector is disposed (for instance, a printed circuit board (PCB)). As previously explained, an overlap between the expansion module and the reference surface of the electronic device may result in a reduction of the available space on the reference surface. In some examples, the card connector may be arranged to hold the expansion module in a vertical position to reduce the overlap. In the vertical position, a long edge of the expansion module is substantially orthogonal to the reference surface on which the card connector is disposed. In some examples, to hold an expansion module in a vertical position, a card connector may comprise a protruding portion substantially orthogonal to a base portion, the base portion being parallel to a reference surface of an electronic device (e.g., a PCB).

As used herein, the term “substantially orthogonal” will be used to refer to configurations in which a first element and a second element are at an angle within a range from about 85° to about 95°. Accordingly, a card connector in which the protruding portion is substantially orthogonal to the base portion refers to a protruding portion having a surface at an angle between about 85° and about 95° with respect to a reference surface of the base portion (e.g., an upper surface to contact an edge of the expansion module or a base of base portion that is to contact with a reference surface in a computing device). Also, as used herein, the term “substantially parallel” will be used to refer to configurations in which a first element and a second element are at an angle within a range from about −5° to about +5°.

Referring now to FIG. 1, a card connector 100 is shown. The card connector 100 may be used for connecting an expansion module (not shown in FIG. 1) to a component of an electronic device (for instance, a connector on a PCB). The card connector 100 comprises a clamp member 110 including a connector 111, and a holder member 120. The holder member 120 comprises a base portion 121 and a protruding portion 122. The base portion 121 defines an aperture 121a to receive the connector 111 of the clamp member 110 and the protruding portion 122 extends from the base portion 121. The aperture 121a defined by the base portion 121 is defined in between a pair of flanges of the base portion 121. The protruding portion 122 of the holder member 120 comprises an inner surface to provide a first support surface for holding the expansion module. In FIG. 1, the inner surface corresponds to a surface of the protruding portion 122 that faces the clamp member 110 upon the connector 111 being received in the aperture 121a. On the other hand, a second support surface for holding the expansion module is defined in a region of the connector 111 that faces the protruding portion 122 upon the connector 111 being received in the aperture 121a. The first and second support surfaces may be used to contact opposite surfaces of the expansion module. In some examples, the first and the second surfaces may be substantially orthogonal to a base of the base portion 121, the base of the base portion 121 corresponding to a bottom surface of the base portion 121 that is to contact a component of the electronic device (for instance, a PCB).

In FIG. 1, the clamp member 110 is represented at a distance with respect to the holder member 120. However, upon the connector 111 of the clamp member 110 being received in the aperture 121a defined by the base portion, a gap to receive the expansion module is defined in between the clamp member 110 and the protruding portion 122. Then, upon insertion of the expansion module into the gap between the clamp member 110 and the protruding portion 122, the connector 111 of the holder member 120 is to engage with a complementary connector of the expansion module.

In some examples, the card connector 110 may be used to operatively connect an expansion module to a component of a computing device (for instance, a PCB). In an example, upon the connector 111 of the clamp member 110 being received in the aperture 121a of the base portion 121, a base of the connector 111 is aligned with a bottom surface of the base portion 121. In some examples, the connector 111 may comprise a plurality of protruding pins to engage with each of the complementary connector of the expansion module and the component of the electronic device.

In the card connector 100 of FIG. 1, the protruding portion 122 of the holder member 120 is substantially orthogonal to a base of the base portion 121 and the connector 111 of the clamp member 110 comprises a portion substantially parallel to the protruding portion 122 of the holder member 120. As a result, upon insertion of the expansion module into the gap defined in between the protruding portion 122 and the connector 111 of the clamp member 110, the expansion module is held in place in a vertical position. In the vertical position, a reduction of the available space on a reference surface to which the expansion module is to be connected is reduced.

In some examples, the clamp member 110 and the holder member 120 of the card connector 100 may include apertures for receiving fixing members. In an example, the fixing members may be used to fix a position of the clamp member 110 with respect to the holder member 120. In other examples, the fixing members may be used to fix a position of the clamp member 110 with respect to the holder member 120 and to fix a position of the holder member 120 with respect to a reference surface (for instance, a PCB). In some examples, the holder member 120 may comprise a plurality of apertures and the clamp member 110 may comprise a plurality of complementary apertures aligned with the plurality of apertures of the holder member 120. In an example, the protruding portion 122 of the holder member 120 may comprise a plurality of apertures and the clamp member 110 may comprise a plurality of complementary apertures aligned with the plurality of apertures of the protruding portion 122. In some other examples, the base portion 121 of the holder member 120 may comprise a first plurality of apertures and the protruding portion 122 of the holder member 120 may comprise a second plurality of apertures. Accordingly, the clamp member 110 may comprise a first plurality of complementary apertures and a second plurality of complementary apertures. The first plurality of apertures of the holder member 120 may be used for fixing a position of the clamp member 110 with respect to the protruding portion 122 and the second plurality of apertures may be used for fixing a position of the holder member 120 with respect to a reference surface. Examples of fixing members comprise pins, screws, rivets, adhesive, and screw knobs, among others.

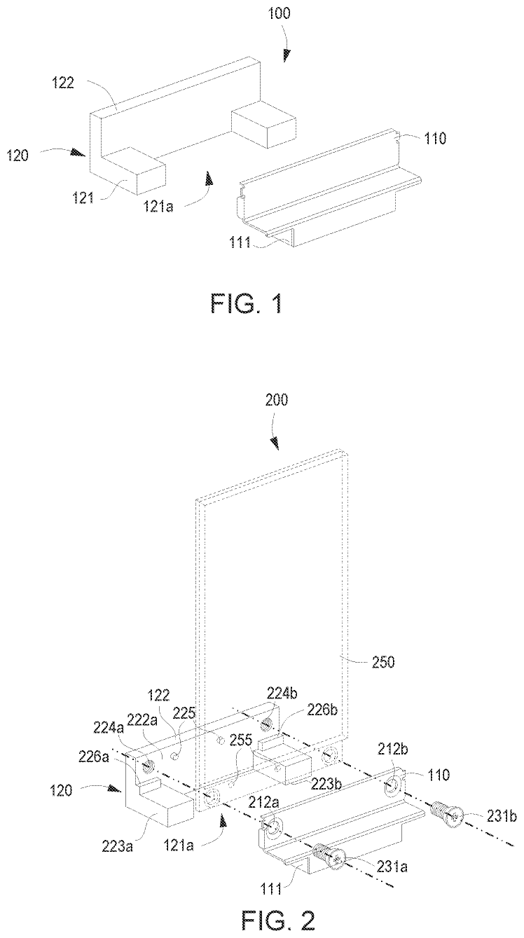

Referring now to FIG. 2, an exploded view of a card connector 200 is shown. For illustrative purposes, an expansion module 250 has also been represented. As previously explained, the card connector 200 may be used for connecting the expansion module 250 to an electronic device. In FIG. 2, the card connector 200 comprises a clamp member 110 and a holder member 120. The holder member 120, which is substantially L-shaped, comprises a protruding portion 122 extending from a base portion comprising a first flange 223a and a second flange 223b at a distance from the first flange 223a and a protruding portion 122. The first and second flanges 223a and 223b define an aperture 121a in the base portion of the card connector 200. As previously explained in FIG. 1, the aperture 121a defined by the base portion is to receive a connector 111 of the clamp member 110. Accordingly, the clamp member 110 of the card connector 200 is arranged such that the connector 111 fits into the aperture 121a.

To fix the clamp member 110 with respect to the holder member 120, the protruding portion 122 of the holder member 120 comprises a first aperture 224a and a second aperture 224b and the clamp member 110 comprises a first corresponding aperture 212a and a second corresponding aperture 212b. Then, upon insertion of fixing members 231a and 231b, the clamp member 110 is fixed with respect the holder member 120. In some examples, the expansion module 250 may include corresponding apertures along a width of the expansion module 250 for receiving the fixing members 231a and 231b. However, in other examples, the apertures 224a, 224b, 212a, and 212b may be arranged at a distance greater than the width of the expansion module 250.

The protruding portion 122 of the card connector 200 comprises a plurality of alignment pins 225. In FIG. 2, the alignment pins 225 in the card connector 220 are in the form of protruding elements distributed along an inner surface 222a of the protruding portion 122. The plurality of alignment pins 225 may be used to assist in positioning the expansion module 250 with respect to the holder member 120. The plurality of alignment pins 225 is to be inserted into a plurality of complementary alignment apertures 255 along a width of the expansion module 250. Upon insertion of the plurality of alignment pins 225 into the plurality of complementary apertures 255 and insertion of the connector 111 into the aperture 121a defined by the base portion of the holder member 120, a position of the expansion module 250 with respect to the card connector 200 is fixed.

To horizontally position the expansion module 250 with respect to the holder member 120, the holder member 120 of the card connector 200 further comprises a pair of alignment elements to guide the expansion module 250 towards a position in which the connector 111 of the clamp member 110 is to engage with a complementary connector of the expansion module 250. In FIG. 2, the pair of alignment elements comprises a first alignment element 226a and a second alignment element 226b. In the card connector 200, the alignment elements 226a and 226b span a portion of the width of each of the first flange 223a and the second flange 223b, respectively.

Although the alignment elements 226a and 226b of the card connector 200 span a portion of the width of the first flange 223a and the second flange 223b, it should be noted that, in other examples, the alignment elements 225a and 225b may span the full width of the flanges 223a and 223b. However, in some examples, the width of the alignment elements 226a and 226b may be defined such that the expansion module 250 is received in a space defined from the first alignment element 226a to the second alignment element 226b. Also, in some other examples, the first and second alignment elements 226a and 226b may comprise sloped surfaces arranged to guide the expansion module 250 towards a position in which the connector 111 of the clamp member 110 engages with the complementary connector of the expansion module 250.

As explained above, the clamp member 110 and the protruding portion 122 of the holder member 120 are to receive the expansion module 250 in a gap therebetween. In some examples, the inner surface 222a of the protruding portion 122 may be substantially orthogonal to a bottom surface of the base portion 121 and the connector 111 may comprise a portion substantially parallel to the inner surface 222a. As a result, upon insertion of the expansion module 250 into the gap, the expansion module 250 is held in place in a vertical position. In some examples, the gap may be within a range from about 0.5 mm to about 1.5 mm.

Although the card connector 200 comprises apertures 224a and 224b, alignment pins 225, and alignment elements 226a and 226b it should be noted that, in other examples, a card connector may comprise fewer or different elements. Accordingly, in some examples, a card connector may include alignment elements 226a and 226b spanning the full width of the flanges 223a and 223b, alignment elements 226a and 226b including sloped surfaces, or a card connector comprising apertures in the base portion 121 of the holder member 120.

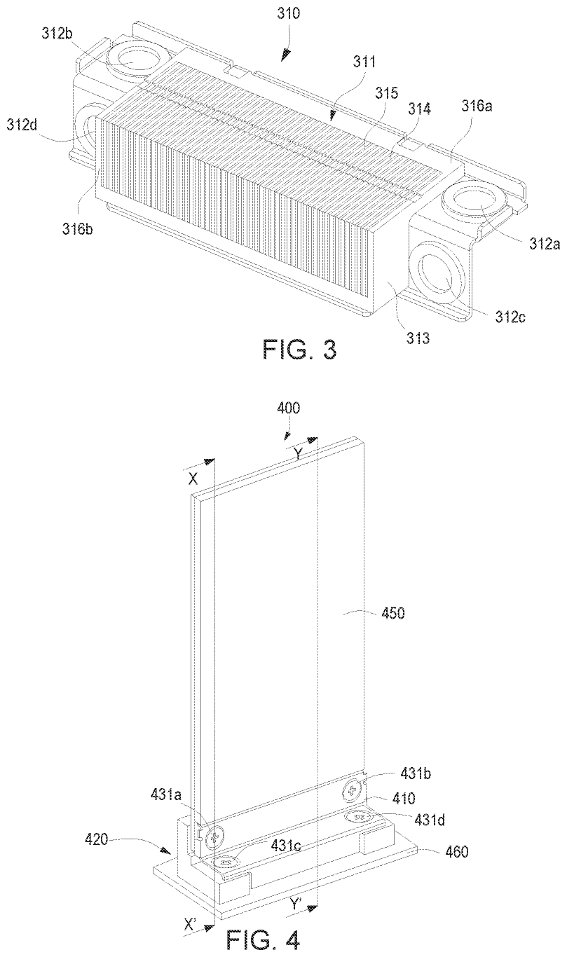

Referring now to FIG. 3, an example clamp member 310 comprising a connector 311 to interface with an expansion module is shown. The connector 311 of the clamp member 310 comprises a body 313 and a plurality of pins 314. Furthermore, the clamp member 310 comprise a plurality of apertures to receive fixing members. The plurality of apertures comprises a first aperture 312a, a second aperture 312b, a third aperture 312c, and a fourth aperture 312d. As previously explained, the apertures 312a to 312d are arranged to be aligned with corresponding apertures in a holder member of a card connector.

The connector 311 of the clamp member 310 is dimensioned so as to fit into an aperture defined by a base portion of the holder member of the card connector. Hence, a width of the connector 311 is equal or smaller than a width of the aperture defined by the base portion. In the clamp member 310, the body 313 of the connector 311 includes a plurality of channels 315. The plurality of channels 315 is to receive the plurality of pins 314, the pins to engage with a complementary connector on the expansion module and a connector of an electronic device within which the card connector may be installed. The body 313 of the connector 311 comprises a first portion 316a and a second portion 316b. The first portion 316a of the body is substantially parallel to a surface of a protruding portion of the holder member facing the connector 311 and the second portion 316b is substantially parallel to a base of the base portion of the holder member.

Upon insertion of the connector 311 in the aperture of the base portion of the holder member, the plurality of pins 314 protrudes from the first portion 316a. The portions of the pins that protrude from the first portion 316a is to engage with the complementary connector of the expansion module. In some examples, the first portion 316a may be arranged to protrude from the aperture defined by the base portion of the holder member to engage with the complementary connector of the expansion module. In regard to the second portion 316b, upon insertion of the connector 311 into the aperture of the base portion, the second portion 316b is aligned with the base of the base portion and the plurality of pins 314 is to protrude from the second portion 316b.

In some examples, each pin of the plurality of pins 314 comprises a first portion substantially parallel to the first portion 316a of the body 313 and a second portion substantially parallel to the second portion 316b of the body 313. To connect a first portion of a pin to a second portion of the pin, the pin may further include a bent region such that the first portion of the pin is at a right angle with respect to the second portion of the pin. However, in other examples, the plurality of pins 314 may be arranged such that an overall length of the pin to contact with each of the expansion module and the electronic device is reduced. In an example, each pin of the plurality of pins 314 includes a bent region in which the pin is bent at an angle greater than about 100°. As a result, the overall pin length is reduced, thereby leading to an improved signal performance with respect to longer pins.

In some other examples, each of the pins of the plurality of pins 314 has a length within a range from about 8 mm to about 15 mm. In some examples, the pins may have a length of about 10 mm. In some examples, the lengths within a range from 8 mm to 15 mm enable the pins to electrically connect the expansion module to the electronic device while preventing electronic communication delays and heat generation along the plurality of pins 314. As explained above, in some examples the pins may be shaped such that the overall length of the pin to contact each of the complementary connector and the connector on the electronic device within which the card connector may be installed is reduced.

In further examples, the clamp members 110 of the card connectors 100 and 200 may correspond to the clamp member 310. In some examples, upon the connector 311 of the clamp member 310 being received in the aperture 121a defined by the base portion 121, a bottom surface in the second portion 315b of the connector 311 is aligned with a base of the base portion 121.

Referring now to FIG. 4, an example card connector 400 holding an expansion module 450 is shown. In particular, the expansion module 450 is held in place in between a clamp member 410 and a holder member 420 of the card connector 400. As previously explained, the clamp member 410 comprises a connector (not shown in FIG. 4) and the holder member 420 comprises a base portion and a protruding portion extending from the base portion. The base portion of the holder member 420 comprises a pair of flanges defining an aperture for receiving the connector of the clamp member 410. In FIG. 4, the card connector 400 is disposed on a printed circuit board 460.

In the card connector 400 of FIG. 4, the expansion module 450 is inserted into a gap in between the connector of the clamp member 410 and an inner surface of the protruding portion of the holder member 420. The insertion of the expansion module 450 into the gap and the insertion of the connector of the clamp member 410 into the aperture defined by the base portion of the holder member 420 results in an engagement of the connector of the clamp member 410 with a complementary connector in the expansion module 450. Similarly, upon insertion of the connector of the clamp member 410 into the aperture defined by the base portion of the holder member 420, the connector of the clamp member 410 interfaces with the printed circuit board 460. As a result, upon insertion of the expansion module 450 into the gap, the connector of the clamp member 410 electrically connects the expansion module 450 to the printed circuit board 460.

In the card connector 400, the holder member 420 comprises a plurality of apertures and the clamp member 410 comprises a plurality of complementary apertures aligned with the plurality of apertures of the holder member 420. The apertures in the clamp member 410 and the holder member 420 may be used to receive fixing members. In particular, in the card connector 400, the plurality of apertures in the holder member 420 comprises a first plurality of apertures in the protruding portion and a second plurality of apertures in the base portion. To effectively position the clamp member 410 with respect to the holder member 420, fixing members 431a, 431b, 431c, and 431d are used. In particular, fixing members 431a and 431b fix a position of the clamp member 410 with respect to the protruding portion of the holder member 420 and fixing members 431c and 431d fix a position of the clamp member 410 with respect to the base portion of the holder member 420. In some examples, the printed circuit board 460 may include apertures to receive the fixing members 431c and 431d. Accordingly, the fixing member 431 and 431d may be used to fix a position of the clamp member 410 with respect to a base portion of the holder member 420 and the printed circuit board 460.

In some examples, the connector of the clamp member 410 may comprise a portion substantially parallel to the protruding portion of the holder member 420, and upon insertion of the connector into the aperture defined by the base portion, the gap in between the connector and the protruding portion is within a range from about 0.5 mm to about 1.5 mm. In some examples, the gap in between the connector and the protruding portion of the holder member 420 is dimensioned to match the thickness of the expansion module 450.

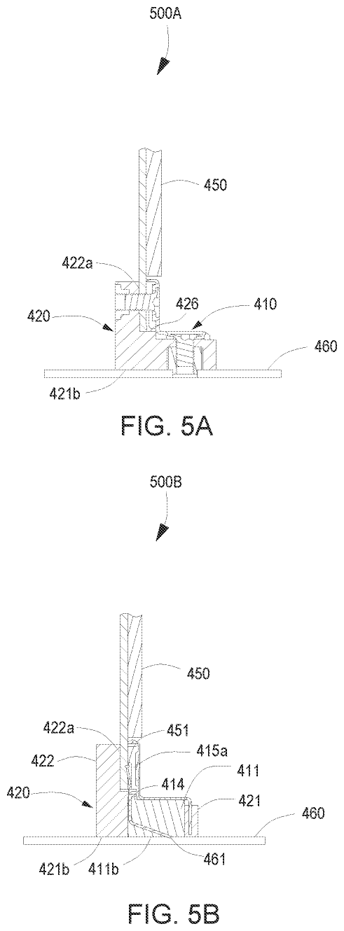

Referring now to FIG. 5A, a cross-sectional view 500A of the card connector 400, the expansion module 450, and the printed circuit board 460 along line X-X′ in FIG. 4 is shown. In the cross-sectional view 500A, a base 421b of the base portion of the holder member 420 contacts the printed circuit board 460. The base 421b corresponds to the bottom surface of the base portion. In FIG. 5A, a connector of the clamp member 410 is inserted into the aperture of the base portion of the holder member 420 and is not fully visible. However, the gap in between an inner surface 422a of the protruding portion and the connector of the clamp member 410 is visible.

As previously explained, the holder member 420 may comprise alignment elements to assist in positioning the expansion module 450 with respect to the holder member 420. In the card connector 400, the holder member 420 comprises a pair of alignment elements to guide the expansion module 450 to a position in which the connector of the clamp member 410 is to engage with a complementary connector of the expansion module 450. In the cross-sectional view 500A, an alignment element in the form of a flange 426 is represented. The flange 426 assists in vertically positioning the expansion module 450 with respect to the holder member 420. In some examples, the flange 426 may comprise a ramp to assist in horizontally positioning the expansion module 450. In an example, the ramp may guide the expansion module 450 towards a centered position in which the complementary connector of the expansion module 450 engages with the connector of the clamp member 410.

Referring now to FIG. 5B, a cross-sectional view 500B of the card connector 400, the expansion module 450, and the printed circuit board 460 along line Y-Y′ in FIG. 4 is shown. In FIG. 5B, the connector 411 of the clamp member is inserted into the aperture defined by the base portion 421 of the holder member 420. The connector 411 comprises a plurality of pins, the pins to protrude from a body of the connector 411. In the cross-sectional view 500B, a pin 414 of the plurality of pins is represented. Upon insertion of the connector 411 into the aperture defined in between the flanges of the base portion 421, a bottom surface 411b of the connector 411 is aligned with the base 421b of the base portion 421.

As explained above, the connector 411 is to electrically connect the expansion module 450 to a component of an electronic device. In FIG. 5B, the connector 411 electrically connects the expansion module 450 to the printed circuit board 460. To connect with the expansion module 450 and the printed circuit board 460, the pin 414 protrudes from the connector 411. In FIG. 5B, the pin 414 contacts a connector of the expansion module 450 at a first contact region 451 and the printed circuit board 460 at a second contact region 461. To reduce an overall length of the pin 414, a first portion of the pin 414 that is to contact the expansion module 450 is at an angle greater than about 100° with respect to a second portion of the pin 414 that is to contact the printed circuit board 460. In some examples, the electrically connect the expansion module 450 to the electronic device, the pins may be made of a conductive material such as brass, copper (e.g., beryllium copper), and bronze (e.g., phosphor bronze). However, other materials may be possible.

In the cross-sectional view 500B, a portion 415a of the connector 411 protrudes from the aperture defined by the base portion 421 and the inner surface 422a of the protruding portion 422 is substantially orthogonal to the base 421b of the portion 415a. In addition, to effectively clamp the expansion module 450 in between the connector 411 and the protruding portion 422, the portion 415a of the connector 411 is substantially parallel to the inner surface 422a of the protruding portion 422.

When using the card connector 400 for holding the expansion module 450 in a vertical position with respect to the printed circuit board 460, a reduction of the available space on the printed circuit board 460 is minimized. In addition, as explained above, the dissipation of heat generated by the expansion module 450 is enhanced compared to other card connector types in which the expansion module 450 is held in a horizontal position with respect to the printed circuit board 460 (on the PCB or at a short distance from a top surface of the PCB).

In some examples, the components of a card connector may be made of different materials. Accordingly, holder members 120 and 420 and the clamp members 110, 310, and 410 previously explained in reference to FIGS. 1 to 4 may be made of a wide variety of materials. In an example, the holder members 120 and 420 may be made of a plastic material, such as a polyester plastic, PC (Polycarbonate) with ABS (Acrylonitrile Butadiene Styrene), or nylon. In other examples, the clamp members 110, 310, and 410 may be made of stainless steel, aluminum, or zinc. In some other examples, the body of a connector 111, 311, and 411 of a clamp member may be made of a plastic material, such as a polyester plastic, PC (Polycarbonate) with ABS (Acrylonitrile Butadiene Styrene), or nylon.

According to some examples, a system board for a computing device may comprise a printed circuit board and a card connector on the printed circuit board to receive an expansion module. The card connector, which may correspond to any of the card connector explained above, may be used to receive the expansion module in a vertical position in which a long edge of the expansion module is orthogonal to the printed circuit board of the system board.

In some examples, a system board may comprise a card connector including a clamp member and a holder member. The clamp member may comprise a connector to receive a complementary connector of the expansion module. The holder member may comprise a base portion defining an aperture to receive the connector of the clamp member and a protruding portion extending from the base portion. In some examples, the protruding portion extends vertically with respect to the printed circuit board of the system board. Upon the connector of the clamp member being inserted into the aperture defined by the base portion, a gap is defined in between the protruding portion and the connector of the clamp member. Then, upon insertion of the expansion module into the gap, the connector of the clamp member is to electrically connect the expansion module to a connector on the printed circuit board.

In some examples, the protruding portion of the system board may comprise an inner surface substantially orthogonal to the printed circuit board, and the connector of the clamp member may comprise a portion substantially parallel to the inner surface of the protruding portion. As a result, the expansion module is held in place in a vertical position. In some examples, the portion of the connector that is substantially parallel to the inner surface protrudes from the aperture upon insertion of the connector into the aperture defined by the base portion.

According to some examples, a computing system may include a printed circuit board, an expansion module, and a card connector to receive the expansion module. The expansion module, for instance, may correspond to a storage module. The card connector may receive the storage module in a vertical position in which a long edge of the storage module is substantially orthogonal to the printed circuit board.

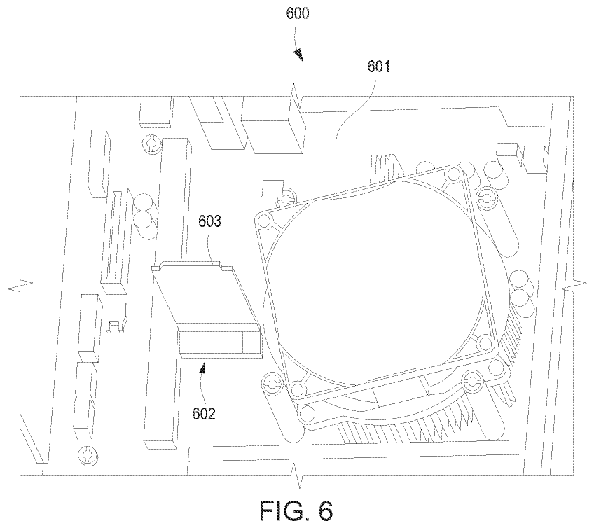

Referring now to FIG. 6, a detailed view of an example computing system 600 is shown. The computing system 600 may correspond, for instance, with a desktop computer or an all-in-one computer. The computing system 600 comprises a printed circuit board 601, a card connector 602, and a storage module 603. The card connector 602 may correspond to any of the card connectors previously explained in reference to FIGS. 1 to 5B.

The card connector 602 of the computing system 600 comprises a clamp member including a connector to engage with a connector of the storage module 603, and a holder member. The holder member comprises a base portion attached to the printed circuit board 601 and a protruding portion extending away from the printed circuit board 601. As previous explained, the base portion defines an aperture arranged to receive the connector of the clamp member. In some examples, the protruding portion of the holder extends in a direction substantially orthogonal to the printed circuit board 601.

The storage module 603 of the computing system 600 is disposed in between the clamp member and the holder member and comprises a complementary connector. Upon the connector of the clamp member being inserted into the aperture defined by the base portion of the holder member, the connector electrically connects the storage module 603 to the printed circuit board 601.

In the computing system 600, the storage module 603 has a long edge and a short edge, and the base portion of the holder member spans a storage module width along the short edge. Furthermore, to avoid the storage module to fall into the aperture defined by the base portion, the aperture has an aperture width smaller than the storage module width. In some examples, the holder member may comprise alignment elements so as to guide the storage module to a position in which the connector of the clamp member engages with the complementary connector of the storage module 603 upon insertion of the connector into the aperture defined by the base portion.

In some examples, the protruding portion of the holder member may comprise a plurality of alignment pins distributed along an inner surface of the protruding portion and the storage module 603 may comprise a plurality of complementary alignment apertures to receive the plurality of alignment pins. Upon insertion of the plurality of alignment pins into the plurality of alignment apertures of the storage module 603, the storage module 603 is guided towards a position in which the connector of the clamp member engages with the complementary connector of the storage module 603.

In some other examples, the holder member of the card connector 602 further comprises a pair of alignment elements in opposite ends to assist in positioning the storage module 603. In an example, the pair of alignment elements is to guide the storage module 603 towards a position in which the connector of the storage module engages with the complementary connector of the storage module 603.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A card connector comprising:
a clamp member comprising a connector; and
a holder member comprising:
a base portion defining an aperture to receive the connector of the clamp member, and
a protruding portion extending from the base portion;
wherein upon the connector being received in the aperture defined by the base portion, the clamp member and the protruding portion of the holder member are to receive an expansion module in a gap therebetween and, and upon insertion of the expansion module into the gap, the connector of the clamp member is to engage with a complementary connector of the expansion module.

2. The card connector of claim 1, wherein the protruding portion of the holder member is substantially orthogonal to a base of the base portion, and the connector of the clamp member comprises a portion substantially parallel to the protruding portion of the holder member.

3. The card connector of claim 1, wherein:
the protruding portion of the holder member comprises a plurality of apertures and the clamp member comprises a plurality of complementary apertures aligned with the plurality of apertures of the holder member, and
the plurality of apertures and the plurality of complementary apertures are to receive fixing members to fix a position of the clamp member with respect to the holder member.

4. The card connector of claim 3, wherein the plurality of apertures of the holder member comprises a first plurality of apertures in the protruding portion and a second plurality of apertures in the base portion.

5. The card connector of claim 1, wherein upon the connector of the clamp member being received in the aperture of the base portion, a bottom surface of the connector is aligned with a base of the base portion.

6. The card connector of claim 5, wherein the connector of the clamp member comprises:
a plurality of pins; and
a body comprising channels for the plurality of pins, the body comprising a first portion substantially parallel to a surface of the protruding portion facing the connector and a second portion substantially parallel to a base of the base portion and including the bottom surface,
wherein upon insertion of the connector in the aperture of the base portion, the plurality of pins is to protrude from the first portion of the body to engage with the complementary connector of the expansion module, the second portion is aligned with the base of the base portion, and the plurality of pins is to protrude from the second portion.

7. The card connector of claim 6, wherein each pin of the plurality of pins includes a bent region in which the pin is bent an angle greater than 100°.

8. The card connector of claim 1, wherein the holder member further comprises a pair of alignment elements to guide the expansion module towards a position in which the connector of the clamp member is to engage with the complementary connector of the expansion module.

9. The card connector of claim 1, wherein:
the protruding portion comprises a plurality of alignment pins distributed along an inner surface, and
upon insertion of the expansion module in the gap, the plurality of alignment pins is inserted in a plurality of apertures of the expansion module.

10. A system board comprising:
a printed circuit board; and
a card connector on the printed circuit board, the card connector comprising:
a clamp member including a connector to receive a complementary connector of an expansion module; and
a holder member comprising:
a base portion defining an aperture to receive the connector of the clamp member, and
a protruding portion extending from the base portion;
wherein upon the connector of the clamp member being inserted into the aperture defined by the base portion, a gap is defined in between the protruding portion and the connector of the clamp member, and upon insertion of the expansion module into the gap, the connector of the clamp member is to electrically connect the expansion module to a connector on the printed circuit board.

11. The system board of claim 10, wherein:
an inner surface of the protruding portion of the holder member is substantially orthogonal to the printed circuit board,
the connector of the clamp member comprises a portion substantially parallel to the inner surface, and
upon insertion of the connector into the aperture defined by the base portion, the portion protrudes from the aperture.

12. A computing system comprising:
a printed circuit board;
a card connector comprising:
a clamp member comprising a connector, the connector to engage with a complementary connector of a storage module,
a holder member comprising a base portion attached to the printed circuit board and a protruding portion extending away from the printed circuit board, the base portion defining an aperture arranged to receive the connector of the clamp member; and
a storage module disposed in between the clamp member and the holder member, the storage module comprising a complementary connector,
wherein upon the connector of the clamp member being inserted into the aperture defined by the base portion of the holder member, the connector electrically connects the storage module to the printed circuit board.

13. The system of claim 12, wherein the storage module has a long edge and a short edge, wherein the base portion of the holder member spans a storage module width along the short edge and the aperture of the base portion has an aperture width smaller than the storage module width.

14. The system of claim 12, wherein the protruding portion comprises a plurality of alignment pins distributed along an inner surface of the protruding portion and the storage module comprises a plurality of complementary alignment apertures to receive the plurality of alignment pins, wherein upon insertion of the plurality of alignment pins into the plurality of complementary alignment apertures of the storage module, the storage module is guided towards a position in which the connector of the clamp member engages with the complementary connector of the storage module.

15. The system of claim 12, wherein the holder member further comprises a pair of alignment elements in opposite ends, the pair of alignment elements to guide the storage module towards a position in which the connector of the clamp member engages with the complementary connector of the storage module.
